(19) United States
(12) Patent Application Publication
(10) Pub. No.: US 2004/0098463 A1
(43) Pub. Date: May 20, 2004

(54) Transcoding-enabled caching proxy and method thereof

(76) Inventors: Bo Shen, Fremont, CA (US); Sung-Ju Lee, Los Atos, CA (US)

Correspondence Address: HEWLETT-PACKARD COMPANY, Intellectual Property Administration, P.O. Box 272400, Fort Collins, CO, 80527-2400, US

(21) Appl. No.: 10/300,246

(22) Filed: Nov. 19, 2002

(51) Int. Cl. G06F 15/167; G06F 15/16

(52) U.S. Cl. 709/213; 709/246

(57) ABSTRACT

Methods and systems for delivering content are described. A first version of a content object is received at a caching proxy from a content source. The first version of the content object is transcoded at the caching proxy to create a second version. A decision is made whether to cache at the caching proxy at least one of the first and second versions. The decision is made according to a caching strategy and then implemented.

### TECHNICAL FIELD

Embodiments of the present invention relate to content delivery networks. More specifically, embodiments of the present invention relate to caching proxies.

### BACKGROUND ART

Before the widespread use of caching in the Internet, an item of content (a content object) requested by a client was likely provided by the original content server (the source of the content object). The content source and the client were typically located at a substantial distance from each other, which often led to slow response times, low bandwidths, high loss rates, and lack of scalability. Response times, bandwidths, and loss rates could also be significantly affected when multiple clients attempted to request an object from the content source at the same time.

Different forms of caching, such as content delivery networks, have helped to overcome some of these problems. Generally, content delivery networks place servers, which may be more specifically referred to as caching proxies, nearer to clients. Content objects can be replicated and cached at each of the caching proxies. Caching of content on caching proxies closer to clients has resulted in a number of improvements, including reduced response times, higher bandwidths, lower loss rates, improved scalability, and reduced requirements for network (backbone) resources.

Content delivery networks work well when the size of the content is relatively small in comparison to the size of the caches. For example, a Web page is generally much less than a megabyte in size. As such, this kind of content can be practically replicated at each caching proxy. Multiple instances of Web content can be stored on each caching proxy without the need for substantial memory resources, or without consuming a significant portion of available memory.

However, caching can be problematic when the content includes multimedia data, which can be large in size as well as long in duration. Even a large cache can hold only a few items of multimedia content before getting filled. For example, a video of DVD (digital video disk) quality may be up to 4.7 gigabytes (GB) in size and up to two hours long (based on Moving Picture Expert Group-2 compression). Consequently, a 50 GB cache can hold only about ten DVD-quality videos. Thus, replicating a large number of DVD-quality videos and storing copies of each video at caching proxies closer to clients is not a practical solution for multimedia data. Memories would need to be very large, or only a small number of videos could be stored. On the other hand, storing large items of multimedia content only at a central source or only at a limited number of caching proxies reintroduces the problems mentioned above.

The problems described above are exacerbated when considering that not only is there a multiplicity of different content objects, but there are likely multiple versions of each object. Different versions may exist to accommodate the variety of different types of network connections utilized by end users. For example, each content object may be encoded at one bitrate for dial-up connections and at another bitrate for broadband connections. In addition, different versions may exist to accommodate the different capabilities provided by the different types of client devices currently in use (e.g., desktops, laptops, personal digital assistants, cell phones, etc.). Different classes of devices typically have different processing and display capabilities. For example, while a personal digital assistant can receive and display a streamed video, it does not have the processing and display capabilities of a desktop. Accordingly, a reduced bitrate/reduced resolution version of the video is produced for use on the personal digital assistant, while the desktop uses a different version at a higher bitrate and higher resolution. In general, different versions of each content object will typically exist in order to accommodate the different types of client devices and the different types of connections in use.

Caching proxies treat requests for objects individually, even if the requests are made for different versions of the same object. As a consequence, each caching proxy is likely to be storing different versions of the same object. Different versions of the same object may also be present at the content source. Storage at caching proxies provides some advantages over storing at the content source, as described above. However, in either case, storage space is being used inefficiently.

Accordingly, a more efficient way of delivering content objects to end-users is desirable. Embodiments of the present invention provide such an improvement.

### DISCLOSURE OF THE INVENTION

Embodiments of the present invention pertain to methods and systems for delivering content. A first version of a content object is received at a caching proxy from a content source. The first version of the content object is transcoded at the caching proxy to create a second version. A decision is made whether to cache at the caching proxy at least one of the first and second versions. The decision is made according to a caching strategy and then implemented.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 illustrates a system for delivering content according to one embodiment of the present invention.

FIG. 2 is a block diagram illustrating the functional elements provided by a caching proxy in accordance with one embodiment of the present invention.

FIG. 3 is a flowchart of a method for delivering content according to one embodiment of the present invention.

FIG. 4 is a flowchart of a method for transcoding and caching data according to one embodiment of the present invention.

The drawings referred to in this description should not be understood as being drawn to scale except if specifically noted.

### BEST MODE FOR CARRYING OUT THE INVENTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of the present invention, numerous specific details are set forth in order to provide a thorough understanding of the present invention. In other instances, well-known methods, procedures, components, and circuits have not been described in detail as not to unnecessarily obscure aspects of the present invention.

The embodiments of the present invention are well suited to use with video-based data, audio-based data, image-based data, Web page-based data, graphics data and the like that are generally referred to herein as media data, multimedia data, content, or content objects. For purposes of clarity and brevity, the following discussion and examples sometimes deal specifically with video data. The embodiments of the present invention, however, are not limited to use with video data.

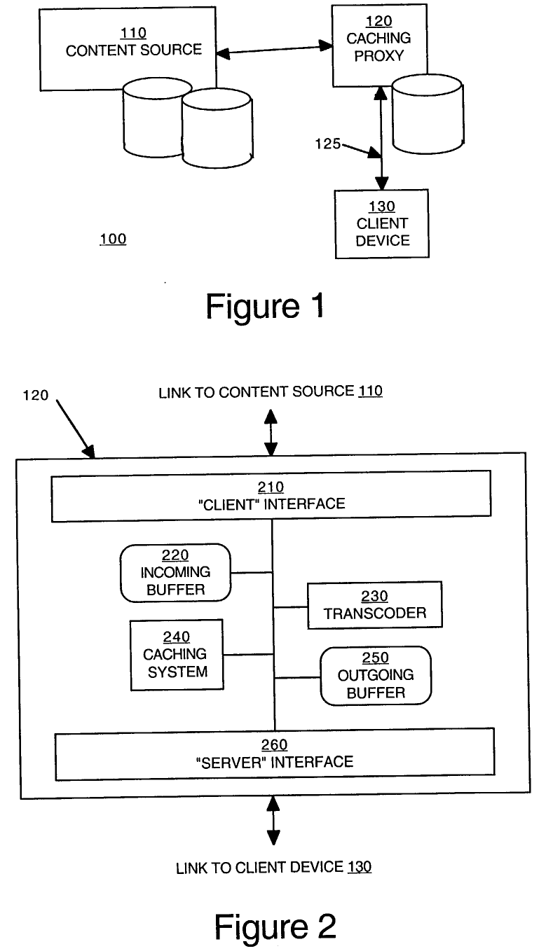

FIG. 1 illustrates a network or system 100 for delivering content according to one embodiment of the present invention. It is appreciated that system 100 may include elements other than those shown. System 100 may also include more than one of the various elements shown. The functionality of each of these elements is discussed below; it is appreciated that these elements may implement functionality other than that discussed.

In the present embodiment, the various elements of system 100 are in communication with each other as illustrated. That is, in the present embodiment, content source 110 communicates with caching proxy 120, which in turn communicates with client device 130 via a communication channel 125. Generally speaking, caching proxy 120 is typically deployed at the edge of the network or system 100 to reduce traffic to and from content source 110, and to also reduce latency as perceived by client device 130. As will be seen, according to the various embodiments of the present invention, caching proxy 120 incorporates the functionality of a transcoder; thus, caching proxy 120 performs transcoding as well as caching.

Client device 130 may be a computer system (such as a laptop, desktop or notebook), a hand-held device (such as a personal digital assistant), a cell phone, or another type of device that, in general, provides the capability for users to access and execute (e.g., display) items of content. As mentioned above, there may actually be many client devices with access to caching proxy 120. In a heterogeneous network, each of these client devices may have different attributes or profiles. These attributes include, but are not limited to, the display, power, communication and computational capabilities and characteristics of the various client devices.

Communication may occur directly between elements, or indirectly through an intermediary device or node (not shown). Also, communication may be wired or wireless, or a combination of wired and wireless. In one embodiment, communication occurs over the World Wide Web (or Internet). There may actually be many communication channels downstream of caching proxy 120. In a heterogeneous network, each of these communication channels (exemplified by communication channel 125) may have different attributes. For example, one channel may be characterized as having a higher bandwidth (higher data transfer rate) than another channel.

FIG. 2 is a block diagram showing the functional elements provided by a caching proxy 120 in accordance with one embodiment of the present invention. In the present embodiment, caching proxy 120 includes a client interface 210, an incoming buffer 220, a transcoder 230, a caching system 240, an outgoing buffer 250, and a server interface 260. These elements are rendered separately for clarity of illustration and discussion; however, it is understood that these elements may not exist as separate entities within caching proxy 120. For example, incoming buffer 220, caching system 240, and outgoing buffer 250 may be embodied in a single memory unit, and transcoder 230 may be embodied in hardware, firmware, or software, perhaps stored as computer-readable instructions within the same memory unit as the caching system and buffers. Similarly, client interface 210 and server interface 260 may be embodied as software, firmware or hardware within separate elements or within a same element. In general, according to the various embodiments of the present invention, caching proxy 120 provides the capability and functionality provided by the various elements of FIG. 2. In addition, caching proxy 120 may provide other capabilities and functionalities in addition to those described herein.

In the present embodiment, client interface 210 allows caching proxy 120 to act as a client to content source 110. In one embodiment, client interface 210 acts as an HTTP (HyperText Transfer Protocol) client or as an RTP/RTSP (Real Time Protocol/Real Time Streaming Protocol) client. In a somewhat similar manner, server interface 260 allows caching proxy 120 to act as a server to the end user (e.g., client device 130). In one embodiment, server interface 260 acts as an HTTP client or as an RTP/RTSP client. Other protocols can be used with client interface 210 and server interface 260.

In the present embodiment, caching proxy 120 functions as follows for video delivery. Streamed content is received over the link (or uplink) from content source 110. The content may or may not be compressed (encoded). The content may or may not be encrypted. The received stream (specifically, some portion of the received stream) may be buffered in incoming buffer 220, cached in caching system 240, or sent directly to transcoder 230. The received stream may also be sent over the link (or downlink) to client device 130 via server interface 260.

For the case in which the received stream is buffered, transcoder 230 will continuously pull bits from incoming buffer 220 for transcoding. Transcoder 230 may also retrieve cached objects from caching system 240 for transcoding. Transcoded bits may be sent from transcoder 230 to caching system 240, to outgoing buffer 250, or to server interface 260. Caching proxy 120 can make a decision whether to cache a content object either from incoming buffer 220, outgoing buffer 250, or from transcoder 230 (as the transcoded version is produced). Server interface 260 can also receive transcoded bits from outgoing buffer 250 or from caching system 240 (either directly or via outgoing buffer 250).

In general, a video stream may take a number of different routes through caching proxy 120 depending, for example, on the speed of the uplink, the downlink, and/or the transcoder 230. A number of different streams may be processed in parallel by caching proxy 120. While processed in parallel, one stream may be at one stage of processing, while another steam may be at a different stage.

The sizes of the incoming buffer 220 and the outgoing buffer 250 can be small because transcoder 230 will process content in a streamlined fashion. Transcoding may be from a higher bitrate to a lower bitrate, from a higher resolution to a lower resolution, or a combination of both. Any of various transcoding schemes may be used by transcoder 230. In one embodiment, a compressed domain transcoding approach known in the art is used. In compressed domain transcoding, the incoming video (which is typically encoded) is only partially decoded (decompressed). Rate adapting is performed in the compressed domain while the motion information is reused. Compressed domain transcoding can considerably improve transcoding speed relative to other approaches in which the video is decoded, transcoded and then re-encoded.

The speed of the transcoding process can be measured by the transcoding bitrate, defined as the number of bits the transcoder 230 generates with time (e.g., bits per second). With a transcoding bitrate greater than or equal to the minimum of either of the uplink or downlink bandwidths, transcoder 230 will not introduce a delay in the delivery of a content object from content source 110 to client device 130.

To summarize to this point, according to the embodiments of the present invention, caching proxy 120 performs transcoding as well as caching, allowing content adaptation to be performed closer to the edges of the network (e.g., system 100 of FIG. 1). Caching proxy 120 can transcode content objects into different versions (or variants) in order to satisfy end users in a heterogeneous network (that is, a network composed of client devices that have different attributes, and further composed of different types of communication channels). Depending on the type (e.g., speed) of the connection with a client device 130, as well as the attributes of the client device 130, caching proxy 120 can (if necessary) transcode a content object that is either received from content source 110 or from caching system 240, and deliver the appropriate version of the content object to the client device 130.

In essence, caching proxy 120 trades off computational effort for storage; however, as discussed above, in some instances the computational effort associated with transcoding will not introduce a delay in the delivery of a content object from content source 110 to client device 130. As will be seen, this can result in more efficient use of the cache space available on caching proxy 120. Also, because of the transcoding capability provided by caching proxy 120, it is not necessary for different versions of each content object to be stored at content source 110. Instead, a single version (generally, at the highest bitrate) is stored at content source 110. Thus, the memory space available at content source 110 is also more efficiently utilized.

As mentioned above, caching proxy 120 of FIG. 2 can make a decision whether to cache a content object (specifically, a version of the content object) either from incoming buffer 220, outgoing buffer 250, or from transcoder 230 (as the transcoded version is produced). Different versions of a particular content object are certainly possible and may exist. Various caching schemes or strategies may be employed in order to determine which version or versions should be cached at caching proxy 120. Note that caching proxy 120 may determine not to cache a particular version according to the caching scheme in use. Also, caching proxy 120 may ascertain that there were packet losses in the uplink while a version of a content objects was being retrieved from content source 110, and so a decision may be made not to cache that version if the packet losses were significant enough to effect video quality, for example.

If a version X can be obtained by transcoding from a version Y, then version Y can be referred to as a transcodable version of version X. Conversely, version X can be referred to as a transcoded version of version Y. In video transcoding, a higher bitrate version can be transcoded into a lower bitrate version. For example, a video at a bitrate of 64 Kbps (kilobits per second) can be transcoded from the same video at a bitrate of 128 Kbps. However, a transcoded version may have some loss of fidelity relative to the transcodable version. Caching proxy 120 of FIG. 2 can produce transcoded versions with 1 to N−1 loss in fidelity, where N is the total number of possible versions. For video transcoding, this loss in fidelity is considered to be negligible, particularly when bitrate reduction is coupled with resolution reduction. For example, when a video clip with CIF (Common Intermediate Format) resolution (352×288) at a bitrate of 1 Mbps (megabits per second) is to be delivered to a device with the capability of resolution at QCIF (Quarter CIF, 176×144), the reduction in resolution alone reduces the bitrate by a factor of approximately four.

Client device 130 may either specify a certain version of a content object in a request (based on user input, for example), or agent software resident on client device 130 may inform caching proxy 120 of the capabilities of client device 130 (including the connection speed). In the former case, a user aware of the capabilities of client device 130 and the type of connection may select (e.g., from a menu) a particular version of the content object. In the latter case, caching proxy 120 may select a version corresponding to the type of connection and the capabilities of client device 130.

Consider a case in which N versions of a content object exist at bitrates B₁, B₂, . . . , B_{N}, where B₁>B₂ . . . B_{N}. When a version at bitrate B_{J} is requested by client device 130, different types of responses are possible. In a first type of response, version B_{J} may be available from caching system 240 of caching proxy 120. That is, version B_{J} may have been previously received from content source 110. Alternatively, a transcodable version of B_{J} may have been received from content source 110, the transcodable version was transcoded into version B_{J}, and then version B_{J} was cached in caching system 240. In either case, version B_{J} is available from caching proxy 120. The case in which the requested version of a content object resides in caching system 240 is referred to herein as an exact hit.

In a second type of response, version B_{J} is not available from caching system 240; however, a transcodable version (e.g., version B_{I} having a higher bitrate than B_{J}) is available from caching system 240. That is, version B_{I} may have been previously received from content source 110. Alternatively, a transcodable version of B_{I} may have been received from content source 110, the transcodable version was transcoded into version B_{I}, and then version B_{I} was cached in caching system 240. In either case, version B_{I} is available from caching proxy 120. Accordingly, caching proxy 120 transcodes version B_{I} into version B_{J} instead of receiving (fetching) version B_{J} from content source 110. The case in which the requested version does not reside in caching system 240, but in which a transcodable version does, it referred to herein as a transcode hit.

In a third type of response, neither the requested version nor a transcodable version is available from caching system 240. This case is referred to herein as a miss. In this case, the requested version, or a transcodable version of the requested version, is retrieved from content source 110. Because caching proxy 120 provides transcoding functionality, content source 110 can store only a single bitrate version of the content object (most probably, a high bitrate version, so as to provide a version that can be transcoded into multiple lower bitrate versions).

Different types of caching strategies or schemes may be used by caching proxy 120 to arrive at a decision with regard to which version or versions of a content object are to be stored in caching system 240. In one embodiment, a caching strategy is employed in which only one version of each content object can be stored in caching system 240. In another embodiment, a caching strategy is employed in which multiple versions of each content object may be stored in caching system 240. Caching strategies in which only one version of an object is cached are discussed first; a caching strategy for storing multiple versions of an object is discussed further below.

By caching only one version of each object, storage space is efficiently utilized and more content objects can be stored. However, one of the challenges of such a caching strategy is deciding which version of the object is to be cached. While it may be desirable in some instances to cache in caching system 240 the highest bitrate version, this may not be always desirable. Caching the highest bitrate version will likely result in more frequent transcoding. Also, caching the highest bitrate version may not be the most efficient use of caching system 240, because the highest bitrate version will consume more memory.

In one embodiment of a caching strategy, when a version B_{J} of a content object is requested and that version resides in caching system 240 (e.g., an exact hit), then caching proxy 120 refreshes the access record for that version and that version is retained in caching system 240. An access record is used for recording the history associated with a cached version. For example, the access record may include a time stamp or the like showing each time a particular version was requested. The access record may also include information showing how many times a particular version was requested.

A miss results when a version B_{J} of a content object is requested while version B_{K} resides in caching system 240 (version B_{J} having a higher bitrate than version B_{K}, so that version B_{J} is not transcodable from version B_{K}). According to the present embodiment caching strategy, version B_{K} is removed from caching system 240, version B_{J} is received from content source 110, and version B_{J} is cached in caching system 240 (not necessarily in that order). Thus, in this embodiment, for a miss, the lower bitrate version is evicted from caching system 240 and replaced with the higher bitrate version.

A transcode hit results when a version B_{K} of a content object is requested while a transcodable version B_{J} resides in caching system 240, version B_{J} having a higher bitrate than version B_{K}. In the present embodiment, caching proxy 120 will transcode the cached version B_{J} to the appropriate bitrate B_{K}. In addition, caching proxy 120 has a decision to make as to which version B_{J} or B_{K} to cache.

In one embodiment, caching proxy 120 refreshes the access record of the already-cached object version B_{J}, and does not cache the transcoded version B_{K}. In another embodiment, caching proxy 120 evicts the transcodable version B_{J} from caching system 240 and caches the transcoded version B_{K}.

An embodiment of a caching strategy is now described in which multiple versions of a content object may be cached in caching system 240. By caching multiple versions, the amount of transcoding can be reduced because the likelihood of an exact hit is increased. Caching multiple versions can also increase caching efficiency if the temporal locality of accesses to a certain content object across its variants (versions) is high. For example, over a relatively short period of time, a relatively large number of requests from a variety of different types of client devices (having different attributes) may be received for a certain object. In such a situation, it may be desirable to have multiple versions of that object residing in caching system 240.

In this embodiment of a caching strategy, when there is a miss, caching proxy 120 will receive (fetch) the requested object from content source 110, transcode the object into the requested version if necessary, and cache the object even if other versions of the object already reside in caching system 240. In the present embodiment, in the event of a transcode hit, caching proxy 120 transcodes the transcodable version into the requested version, and stores the transcoded version in caching system 240. An exact hit is treated as described above; that is, the access record for the requested object version is updated, and the object version is retained in caching system 240.

The effectiveness of the caching strategies described above can depend on factors such as the user access behavior and the network environment of the users. For instance, when users in communication with caching proxy 120 have similar network capabilities, then a caching strategy in which only one object version is cached may provide better performance than one in which multiple object versions are cached. A caching proxy having knowledge of which connection bandwidth is predominantly used by its clients can cache only the version of a content object appropriate to the bitrate corresponding to that bandwidth. On the other hand, if caching proxy 120 is coupled in a heterogeneous network (with a variety of client devices and connection types), and the access behavior shows strong temporal locality, then storage of multiple object versions may result in better performance than a caching strategy in which single versions of objects are stored. Furthermore, the effectiveness of caching strategies may be enhanced by introducing prefetching of content objects, or by introducing prefix caching (in which the initial portion of an object is stored in order to reduce latency).

In one embodiment, different caching strategies are adaptively employed by caching proxy 120. For example, depending on the real time behavior exhibited by users, one caching strategy may be selected over another. Access behavior can then be monitored. With changes in access behavior, a different caching strategy is selected by caching proxy 120, based on the factors described above, for example.

Whenever caching system 240 becomes full, it may be necessary to remove a version of an object in order to make room for another object (or another version of the object). Any of various cache replacement schemes known in the art may be used in this event. These cache replacement schemes include least recently used (LRU) schemes, least frequently used (LFU) schemes, LRU-K schemes, GreedyDual (GD) schemes, and the like.

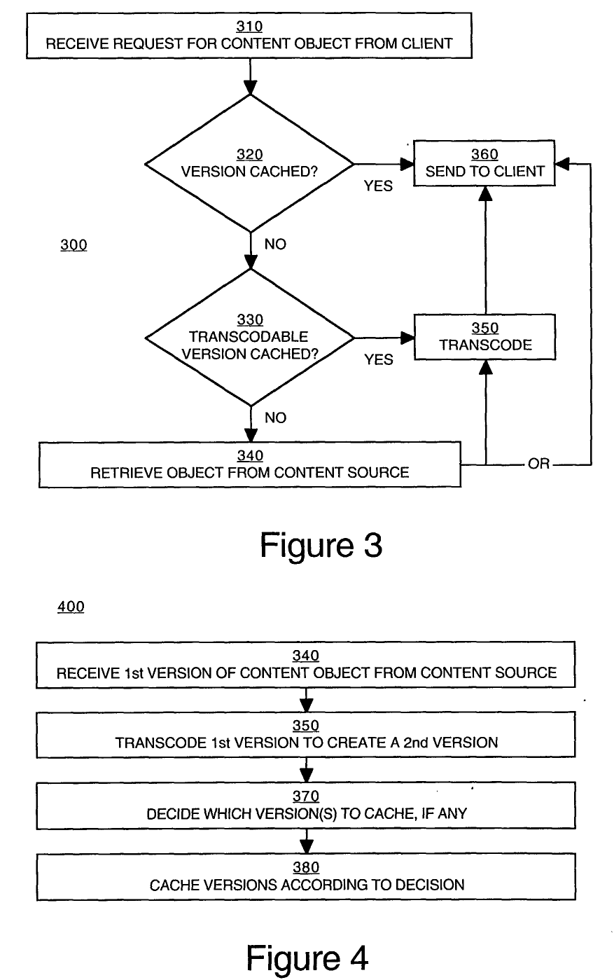

FIG. 3 is a flowchart 300 of a method for delivering content according to one embodiment of the present invention. Although specific steps are disclosed in flowchart 300, such steps are exemplary. That is, embodiments of the present invention are well suited to performing various other steps or variations of the steps recited in flowchart 300. It is appreciated that the steps in flowchart 300 may be performed in an order different than presented, and that not all of the steps in flowchart 300 may be performed. All of, or a portion of, the methods described by flowchart 300 may be implemented using computer-readable and computer-executable instructions which reside, for example, in computer-usable media of a computer system or like device. Generally, flowchart 300 is implemented by devices such as caching proxy 120 of FIGS. 1 and 2.

In step 310 of FIG. 3, in the present embodiment, a request for a content object is received at a caching proxy from a client device (e.g., caching proxy 120 and client device 130 of FIGS. 1 and 2). The caching proxy also receives, or otherwise has knowledge of, the attributes of the client device as well as the type of connection between the caching proxy and the client device. Accordingly, the caching proxy can select the version of the content object to send to the client device. Alternatively, the request from the client device may identify the version of the content object.

In step 320 of FIG. 3, in the present embodiment, a determination can be made with regard to whether or not the object version identified in step 310 is cached in memory at the caching proxy (e.g., in caching system 240 of FIG. 2). If the object version identified in step 310 is cached, it can be sent to the client device (step 360). If not, then flowchart 300 proceeds to step 330. Optionally, portions of the object version may be buffered (e.g., in outgoing buffer 250 of FIG. 2) as it is sent to the client device by the caching proxy.

In step 330 of FIG. 3, in the present embodiment, a determination can be made with regard to whether or not a transcodable version of the object version identified in step 310 is cached in memory at the caching proxy (e.g., in caching system 240 of FIG. 2). If a transcodable version of the object version identified in step 310 is cached, it can be transcoded (step 350) and then sent to the client device (step 360). If not, then flowchart 300 proceeds to step 340.

In step 340 of FIG. 3, in the present embodiment, either the object version requested in step 310, or a transcodable version of that object version, is received from a content source (e.g., content source 110 of FIG. 1). A decision with regard to which version should be provided by the content source can be made by the caching proxy based on access behavior, for example. Optionally, portions of the content object received from the content source can be buffered (e.g., in incoming buffer 220 of FIG. 2) as it is received by the caching proxy.

If the object version requested in step 310 is received, then it can be sent to the client device (step 360). Alternatively, if a transcodable version of that object is received, it can be transcoded (step 350) and then sent to the client device (step 360).

FIG. 4 is a flowchart 400 of a method for transcoding and caching content according to one embodiment of the present invention. Although specific steps are disclosed in flowchart 400, such steps are exemplary. That is, embodiments of the present invention are well suited to performing various other steps or variations of the steps recited in flowchart 400. It is appreciated that the steps in flowchart 400 may be performed in an order different than presented, and that not all of the steps in flowchart 400 may be performed. All of, or a portion of, the methods described by flowchart 400 may be implemented using computer-readable and computer-executable instructions which reside, for example, in computer-usable media of a computer system or like device. Generally, flowchart 400 is implemented by devices such as caching proxy 120 of FIGS. 1 and 2.

In the present embodiment, steps 340 and 350 of FIG. 4 are similar to the same steps described in conjunction with FIG. 3, above. That is, in step 340, a first version of a content object is received at a caching proxy from a content source. Here, the first version is a transcodable version of a second object version. The second version is identified as the version to be provided to a client device, as previously described herein. In step 350, the first version is transcoded by the caching proxy to create the second version.

In step 370 of FIG. 4, in the present embodiment, a decision is made by the caching proxy as to which object version or versions, if any, should be retained or placed into memory (e.g., into caching system 240 of FIG. 2). Different caching strategies, such as those described herein, may be employed by the caching proxy to make this decision. The decision may be to cache only the first version, only the second version, both of the first and second versions, or neither of the first and second versions, according to the caching strategy in place. In one embodiment, depending on factors such as access behavior, a switch may be made to a second caching strategy different from the caching strategy already in place. In step 380, the decision reached in step 370 is implemented by the caching proxy.

Note that a cached object version can serve as a transcodable version of an object identified by a subsequent request received by the caching proxy from a client device. As such, available cache space on the caching proxy is more efficiently used. Also, the number of requests that need to be made to the content source are reduced, reducing the load on the content source and more efficiently utilizing available bandwidth.

Simulation results indicate that, for heterogeneous network conditions, a nearly 20 percent increase in caching performance can be achieved with a manageable computational (transcoding) load. This translates to improved performance of caching proxies as well as content sources, which also translates into reduced delays at client devices. In addition, because the transcoding can occur closer to the end user (e.g., client device), the interaction between the client and the local device (e.g., the caching proxy) is improved.

In summary, embodiments of the present invention pertain to methods and systems that provide a more efficient way of delivering content objects to end-users. According to these embodiments—by adding transcoding capability to a caching proxy—heterogeneity of client devices and network connections is flexibly addressed. A content source can choose to produce a single “master” copy of a content object which can be transcoded as needed, freeing content creators to focus on the creation of content.

Embodiments of the present invention are thus described. While the present invention has been described in particular embodiments, it should be appreciated that the present invention should not be construed as limited by such embodiments, but rather construed according to the following claims.

What is claimed is:

1. A method of delivering content, said method comprising:
receiving at a caching proxy a first version of a content object from a content source;
transcoding at said caching proxy said first version to create a second version of said content object;
making a decision whether to cache at said caching proxy at least one of said first and second versions, said decision made according to a first caching strategy; and
implementing said decision.

2. The method of claim 1 comprising:
caching said first version at said caching proxy;
receiving from a client device a request for said content object, said client device having attributes corresponding to a version of said content object that is transcodable from said first version; and
transcoding said first version according to said attributes.

3. The method of claim 1 comprising:
caching said first version at said caching proxy;
receiving from a client device a request for said content object, said client device having attributes corresponding to a version of said content object that is not transcodable from said first version; and
retrieving from said content source a version of said content object corresponding to said attributes.

4. The method of claim 1 comprising:
caching said second version at said caching proxy.

5. The method of claim 4 comprising:
receiving from a client device a request for said content object, said client device having attributes corresponding to a version of said content object that is transcodable from said second version; and
transcoding said second version according to said attributes.

6. The method of claim 4 comprising:
receiving from a client device a request for said content object, said client device having attributes corresponding to a version of said content object that is not transcodable from said second version; and
retrieving from said content source a version of said content object corresponding to said attributes.

7. The method of claim 1 comprising:
caching both said first version and said second version at said caching proxy.

8. The method of claim 1 wherein said content object comprises video data.

9. The method of claim 1 comprising:
selecting a second caching strategy different from said first caching strategy.

10. The method of claim 1 comprising:
buffering at said caching proxy a portion of said first version of said content object prior to said transcoding.

11. The method of claim 1 comprising:
buffering at said caching proxy a portion of said second version of said content object subsequent to said transcoding.

12. A caching proxy comprising:
a communication link to a content source and a communication link to a client device;
a memory unit coupled to said communication links; and
a processor coupled to said memory unit, said processor for executing a method for delivering content, said method comprising:
receiving a first version of a content object from said content source;
creating a second version of said content object, said second version a transcoded version of said first version; and
determining whether to cache at least one of said first and second versions, wherein a decision regarding whether to cache is made according to a first caching strategy.

13. The caching proxy of claim 12 wherein said method comprises:
caching said first version;
receiving from said client device a request for said content object; and
transcoding said first version according to attributes of said client device when said first version is transcodable into a version substantially compliant with said attributes and otherwise retrieving from said content source a version of said content object corresponding to said attributes.

14. The caching proxy of claim 12 wherein said method comprises:
caching said second version;
receiving from said client device a request for said content object; and
transcoding said second version according to attributes of said client device when said second version is transcodable into a version substantially compliant with said attributes and otherwise retrieving from said content source a version of said content object corresponding to said attributes.

15. The caching proxy of claim 12 wherein said method comprises:
caching both said first version and said second version.

16. The caching proxy of claim 12 wherein said content object comprises video data.

17. The caching proxy of claim 12 wherein said method comprises:
implementing a second caching strategy different from said first caching strategy.

18. The caching proxy of claim 12 wherein said method comprises:
storing a portion of said first version of said content object in a buffer prior to said transcoding.

19. The method of claim 1 comprising:
storing a portion of said second version of said content object in a buffer subsequent to said transcoding.

20. A computer-usable medium having computer-readable program code embodied therein for causing a caching proxy to perform a method for delivering content, said method comprising:
instructing a content source to deliver to said caching proxy a first version of a content object;
transcoding at said caching proxy said first version to create a second version of said content object;
deciding whether to cache at said caching proxy at least one of said first and second versions, wherein a decision whether to cache is made according to a first caching strategy; and
implementing said decision.

21. The computer-usable medium of claim 20 wherein said computer-readable program code embodied therein causes a caching proxy to perform a method for delivering content, said method comprising:
storing said first version at said caching proxy, wherein said first version is available for client devices having attributes corresponding to said first version; and
transcoding said first version for client devices having attributes corresponding to a version of said content object that is transcodable from said first version.

22. The computer-usable medium of claim 20 wherein said computer-readable program code embodied therein causes a caching proxy to perform a method for delivering content, said method comprising:
storing said first version at said caching proxy;
receiving from a client device a request for said content object, said client device having attributes corresponding to a version of said content object that is not transcodable from said first version; and
instructing said content source to provide a version of said content object that corresponds to said attributes.

23. The computer-usable medium of claim 20 wherein said computer-readable program code embodied therein causes a caching proxy to perform a method for delivering content, said method comprising:
storing said second version at said caching proxy, wherein said second version is available for client devices having attributes corresponding to said second version; and
transcoding said second version according to attributes of a client device requesting said content object, said client device having attributes corresponding to a version of said content object that is transcodable from said second version.

24. The computer-usable medium of claim 20 wherein said computer-readable program code embodied therein causes a caching proxy to perform a method for delivering content, said method comprising:
storing said second version at said caching proxy;
receiving from a client device a request for said content object, said client device having attributes corresponding to a version of said content object that is not transcodable from said second version; and
instructing said content source to provide a version of said content object that corresponds to said attributes.

25. The computer-usable medium of claim 20 wherein said computer-readable program code embodied therein causes a caching proxy to perform a method for delivering content, said method comprising:
storing both said first version and said second version at said caching proxy.

26. The computer-usable medium of claim 20 wherein said content object comprises video data.

27. The computer-usable medium of claim 20 wherein said computer-readable program code embodied therein causes a caching proxy to perform a method for delivering content, said method comprising:
changing from said first caching strategy to a second caching strategy.

28. The computer-usable medium of claim 20 wherein said computer-readable program code embodied therein causes a caching proxy to perform a method for delivering content, said method comprising:
buffering at said caching proxy a portion of said first version of said content object prior to said transcoding.

29. The computer-usable medium of claim 20 wherein said computer-readable program code embodied therein causes a caching proxy to perform a method for delivering content, said method comprising:
buffering at said caching proxy a portion of said second version of said content object subsequent to said transcoding.
